(19) United States
(12) Patent Application Publication
(10) Pub. No.: US 2026/0327014 A1
(43) Pub. Date: Oct. 22, 2026

(54) ROLLER DEVICE FOR MAGNETIC FLUID SEALING AND BELT CONVEYOR

(71) Applicant: CCTEG CHINESE INSTITUTE OF COAL SCIENCE, BEIJING (CN)

(72) Inventors: XIAO LIU, BEIJING (CN); HAIJUN WANG, BEIJING (CN); HONGLEI WANG, BEIJING (CN); YIFAN ZHANG, BEIJING (CN); YUE HAN, BEIJING (CN); PENGJUN HAN, BEIJING (CN)

(21) Appl. No.: 19/636,937

(22) Filed: Apr. 2, 2026

(30) Foreign Application Priority Data
Apr. 17, 2025 (CN) 2025104868168

(51) Int. Cl. B65G 39/09; F16C 33/76

(52) U.S. Cl. CPC B65G 39/09; F16C 33/765; B65G 2201/045; F16C 2210/06; F16C 2326/58

(57) ABSTRACT

A roller device includes a rotating member, a mounting seat, a bearing, a sealing assembly, and a first permanent magnet. The bearing contains lubricating fluid and is arranged within the mounting cavity. An end of the rotating member passes through an opening and is fitted in the bearing. The sealing assembly includes a sealing unit and magnetic fluid. The sealing unit is arranged within the mounting seat and fitted over the rotating member, and is located at a side of the bearing adjacent to the opening. An inner circumferential surface of the sealing unit and an outer circumferential surface of the rotating member are spaced apart in an inner-outer direction to form a first gap filled with the magnetic fluid. The first permanent magnet is arranged within the mounting cavity between the sealing assembly and the bearing, and is connected to the sealing assembly.

### CROSS-REFERENCE TO RELATED PATENT APPLICATION

The present application claims the benefit and priority to Chinese patent application No. 2025104868168 filed on Apr. 17, 2025, the content of which is incorporated herein by reference in its entirety for all purposes.

### FIELD OF THE DISCLOSURE

The present disclosure belongs to the field of mining machinery, and particularly relates to a roller device for magnetic fluid sealing and a belt conveyor.

### BACKGROUND OF THE DISCLOSURE

In a belt conveying system in industries such as mines and coal mines, a roller, as an important component of a belt conveyor, often needs to operate for a long time in harsh environments. A sealing structure of the roller is critical to ensuring its normal operation, reducing friction loss, and preventing leakage of lubricating fluid.

In related arts, the sealing structure of the roller suffer from disadvantages such as low sealing efficiency, high maintenance cost, and complex structure.

### SUMMARY OF THE DISCLOSURE

The present disclosure is made based on the inventors' discovery and recognition of the following facts and problems.

In related arts, conventional seals tend to cause increased maintenance costs, environmental pollution, and potential safety hazards due to lubricating fluid leakage. Although emerging magnetic fluid seals can achieve "zero leakage," they face technical bottlenecks in the stability of liquid-liquid interfaces. Existing improved solutions enhance sealing performance by adding a gas isolation layer but introduce problems such as complex structure and increased cost.

The present disclosure aims to solve at least one of the technical problems in related arts to a certain extent.

To this end, embodiments of the present disclosure provide a roller device for magnetic fluid sealing with high sealing efficiency and simple structure.

Embodiments of the present disclosure provide a belt conveyor with long service life and low cost.

A roller device for magnetic fluid sealing according to an embodiment of the present disclosure includes: a rotating member; a mounting seat and a bearing, wherein the mounting seat has an opening and a mounting cavity in communication with each other, the bearing is configured to contain lubricating fluid and is arranged within the mounting cavity, and one end of the rotating member passes through the opening and is fitted within the bearing, so that the rotating member rotates within the mounting seat via the bearing; a sealing assembly including a sealing unit and magnetic fluid, wherein the sealing unit is arranged in the mounting seat and fitted over the rotating member, the sealing unit is located at a side of the bearing adjacent to the opening, an inner circumferential surface of the sealing unit and an outer circumferential surface of the rotating member are spaced apart in an inner-outer direction to form a first gap, and the magnetic fluid fills the first gap so that the sealing assembly seals the bearing; and a first permanent magnet, wherein the first permanent magnet is arranged within the mounting cavity and between the sealing assembly and the bearing, the first permanent magnet is connected to the sealing assembly so that the first permanent magnet magnetizes the sealing unit to increase magnetic field strength between the sealing unit and the rotating member, the first permanent magnet is fitted over the rotating member, and an inner circumferential surface of the first permanent magnet is spaced apart from the outer circumferential surface of the rotating member to form a second gap; a spacing of the first gap is equal to a spacing of the second gap, so that when the lubricating fluid in the bearing flows into the second gap, the first permanent magnet reduces a velocity difference between the magnetic fluid and the lubricating fluid.

A belt conveyor according to an embodiment of the present disclosure includes: a roller device, wherein the roller device is the roller device according to any one of the above embodiments; and a conveyor belt, wherein the conveyor belt is fitted over the roller device so that the roller device drives the conveyor belt to rotate.

### BRIEF DESCRIPTION OF THE DRAWINGS

FIG. 1 is a structural schematic diagram of a roller device for magnetic fluid sealing according to an embodiment of the present disclosure.

FIG. 2 is a partial enlarged view of A in FIG. 1.

### DETAILED DESCRIPTION OF THE EXEMPLARY EMBODIMENTS

Embodiments of the present disclosure will be described in detail below, examples of which are illustrated in the accompanying drawings. The embodiments described below with reference to the accompanying drawings are exemplary and intended to explain the present disclosure, but should not be construed as limiting the present disclosure.

A roller device 100 according to an embodiment of the present disclosure will be described below with reference to the accompanying drawings.

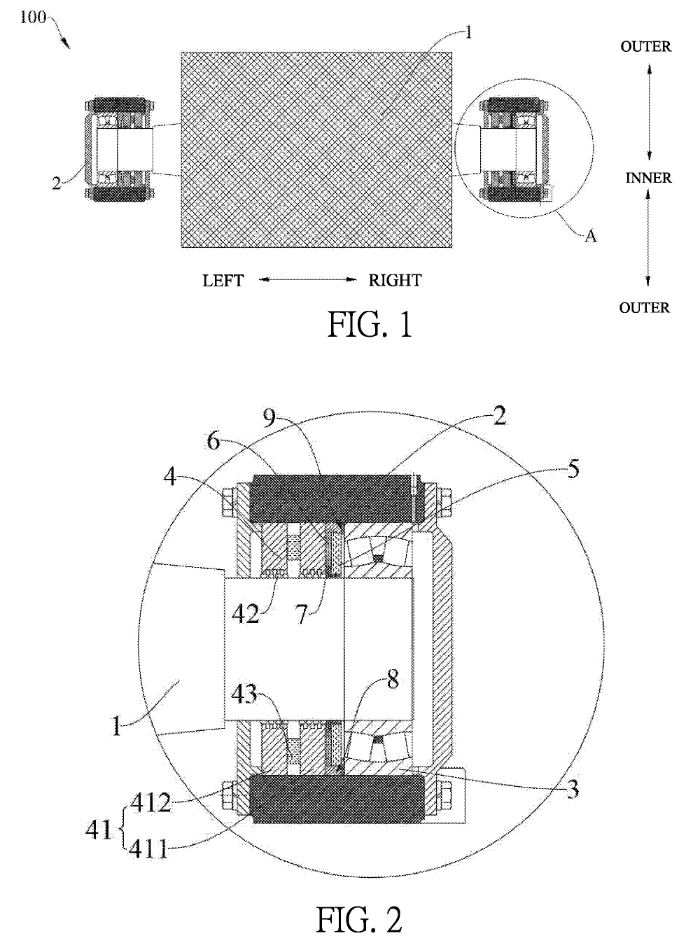

As shown in FIGS. 1–2, the roller device 100 for magnetic fluid sealing according to embodiments of the present disclosure includes a rotating member 1, a mounting seat 2, a bearing 3, a sealing assembly 4, and a first permanent magnet 5.

The mounting seat 2 has an opening and a mounting cavity in communication with each other. The bearing 3 contains lubricating fluid and is arranged within the mounting cavity. One end of the rotating member 1 passes through the opening and is fitted in the bearing 3, so that the rotating member 1 rotates in the mounting seat 2 via the bearing 3. Specifically, as shown in FIGS. 1–2, the mounting seat 2 may be a bearing seat with an opening facing left. The rotating member 1 includes a rotating shaft. An outer ring of the bearing 3 is fixed within the mounting cavity of the mounting seat 2, and the rotating shaft passes through the opening and is fitted in an inner ring of the bearing seat, so that the rotating shaft rotates within the mounting seat 2 via the bearing 3.

The sealing assembly 4 includes a sealing unit 41 and magnetic fluid 42. The sealing unit 41 is arranged within the mounting seat 2 and fitted over the rotating member 1. The sealing unit 41 is located at a side of the bearing 3 adjacent to the opening. An inner circumferential surface of the sealing unit 41 and an outer circumferential surface of the rotating member 1 are spaced apart in an inner-outer direction to form a first gap. The magnetic fluid 42 fills the first gap so that the sealing assembly 4 seals the bearing 3. Specifically, as shown in FIGS. 1–2, the sealing unit 41 is fitted over the rotating member 1 and located at a left end of the bearing 3. The inner circumferential surface of the sealing unit 41 and the outer circumferential surface of the rotating shaft are spaced apart to form the first gap. The magnetic fluid 42 is adsorbed between the sealing unit 41 and the rotating shaft, thereby preventing leakage of the lubricating fluid in the bearing 3 and blocking external impurities from entering the bearing 3 to ensure the service life of the bearing 3.

The first permanent magnet 5 is arranged within the mounting cavity and between the sealing assembly 4 and the bearing 3. The first permanent magnet 5 is connected to the sealing unit 41 so that the first permanent magnet 5 magnetizes the sealing unit 41 to increase magnetic field strength between the sealing unit 41 and the rotating member 1. The first permanent magnet 5 is fitted over the rotating member 1, and an inner circumferential surface of the first permanent magnet 5 is spaced apart from the outer circumferential surface of the rotating member 1 to form a second gap. The spacing of the first gap is equal to the spacing of the second gap, so that when the lubricating fluid in the bearing 3 flows into the second gap, the first permanent magnet 5 can reduce a velocity difference between the magnetic fluid 42 and the lubricating fluid. Specifically, as shown in FIGS. 1–2, the first permanent magnet 5 is arranged within the mounting seat 2 and fitted over the rotating member 1. The first permanent magnet 5 is arranged between the sealing assembly 4 and the bearing 3 and connected to the sealing unit 41, so that the first permanent magnet 5 magnetizes the sealing unit 41 to improve magnetic field strength between the sealing unit 41 and the rotating member 1, thereby enhancing sealing performance and stability of the sealing assembly 4. The first permanent magnet 5 is fitted over the rotating member 1, and the inner circumferential surface of the first permanent magnet 5 and the outer circumferential surface of the rotating member 1 are spaced apart to form the second gap. Since the bearing 3 rotates at a high speed along with the rotating member 1, the lubricating fluid in the bearing 3 flows into the second gap. The rotating member 1 rotates while the first permanent magnet 5 and the sealing unit 41 are stationary. The spacing of the first gap is equal to the spacing of the second gap (in other words, a spacing between the inner circumferential surface of the sealing unit 41 and the outer circumferential surface of the rotating member 1 is equal to a spacing between the inner circumferential surface of the first permanent magnet 5 and the outer circumferential surface of the rotating member 1). Therefore, a rotational speed difference between the magnetic fluid 42 in the first gap and the lubricating fluid in the second gap can be reduced, prolonging the service life of the sealing unit 41. In addition, the arrangement of the first permanent magnet 5 reduces a contact area between the magnetic fluid 42 and the lubricating fluid, further extending the service life of the sealing assembly 4.

In the roller device 100 according to embodiments of the present disclosure, the sealing assembly 4 and the first permanent magnet 5 are provided. The sealing assembly 4 seals the bearing 3 to prevent leakage of the lubricating fluid in the bearing 3, reduce environmental pollution and potential safety hazards, and improve the service life of the device. The first permanent magnet 5 can magnetize the sealing assembly 4 to improve sealing efficiency and sealing performance of the sealing assembly 4. In addition, the first permanent magnet 5 can effectively reduce the velocity difference between the magnetic fluid 42 and the lubricating fluid, improve stability of the magnetic fluid 42 interface, and prolong the service life of the sealing structure.

In some embodiments, the roller device 100 further includes a second permanent magnet 6. The second permanent magnet 6 is fitted over the rotating member 1, and an inner circumferential surface of the second permanent magnet 6 is spaced apart from the outer circumferential surface of the rotating member 1 to form a third gap, so that the magnetic fluid 42 and the lubricating fluid define an air layer in the third gap. The second permanent magnet 6 is located between the sealing assembly 4 and the first permanent magnet 5, and two ends of the second permanent magnet 6 are respectively connected to the first permanent magnet 5 and the sealing unit 41, so that the second permanent magnet 6 magnetizes the sealing unit 41 to increase magnetic field strength between the sealing unit 41 and the rotating member 1. Specifically, as shown in FIGS. 1–2, the second permanent magnet 6 is arranged within the mounting cavity and between the sealing assembly 4 and the first permanent magnet 5. Left and right ends of the second permanent magnet 6 are respectively attached to the sealing assembly 4 and the first permanent magnet 5, so that the second permanent magnet 6 magnetizes the sealing assembly 4 to improve sealing performance of the sealing assembly 4. The inner circumferential surface of the second permanent magnet 6 and the outer circumferential surface of the rotating member 1 are spaced apart to form the third gap. The magnetic fluid 42 in the first gap seals the first gap, and the lubricating fluid in the second gap seals the second gap, so that air is sealed in the third gap to form the air layer, thereby preventing the lubricating fluid from flowing into the magnetic fluid 42 and realizing effective isolation between the magnetic fluid 42 and the lubricating fluid to avoid mixing of the magnetic fluid 42 and the lubricating fluid.

In some embodiments, the first permanent magnet 5 and the second permanent magnet 6 are integrally formed. Specifically, as shown in FIGS. 1–2, the first permanent magnet 5 and the second permanent magnet 6 may be either separately arranged or integrally formed. The separate arrangement facilitates flexible adjustment of a relative position and gap between the first permanent magnet 5 and the second permanent magnet 6, and allows replacement of the first permanent magnet 5 and the second permanent magnet 6 according to magnetization requirements of the sealing assembly 4 to ensure sealing performance of the sealing assembly 4. The integral forming reduces assembly steps, lowers performance deviation caused by assembly errors, enhances structural integrity and durability, and prolongs service life.

In some embodiments, the spacing of the third gap is greater than the spacing of the second gap, and a difference between the third gap and the second gap ranges from 0.01 mm to 1 mm. Specifically, as shown in FIGS. 1–2, the spacing between the inner circumferential surface of the second permanent magnet 6 and the outer circumferential surface of the rotating member 1 is greater than the spacing between the inner circumferential surface of the first permanent magnet 5 and the outer circumferential surface of the rotating member 1. The spacing of the third gap is greater than the spacing of the second gap, and the difference between the third gap and the second gap may be any one of 0.01 mm, 0.03 mm, 0.06 mm, 0.08 mm, 0.09 mm, 1 mm, etc. If the spacing difference is too small or too large, the air layer may fail to stably exist, and the magnetic fluid 42 and the lubricating fluid cannot be effectively isolated, resulting in direct contact and mixing between the magnetic fluid 42 and the lubricating fluid.

In some embodiments, the sealing unit 41 includes a plurality of pole shoes and a third permanent magnet 43.

The plurality of pole shoes are arranged within the mounting seat 2 and fitted over the rotating member 1. A plurality of pole teeth are arranged on an inner circumferential surface of each pole shoe at intervals along the length direction of the rotating member 1. The rotating member 1 is spaced apart from the plurality of pole teeth in the inner-outer direction to form the first gap. Specifically, as shown in FIGS. 1–2, the inner circumferential surface of each pole shoe is provided with a plurality of pole teeth arranged at intervals in a left-right direction. An inner circumferential surface of each pole tooth is spaced apart from the outer circumferential surface of the rotating member 1 to form the first gap, and the magnetic fluid 42 is adsorbed between the pole teeth and the rotating shaft.

The third permanent magnet 43 is arranged in the mounting seat 2 and fitted over the rotating member 1. The permanent magnet is arranged between two adjacent pole shoes. A polarity of the third permanent magnet 43 at a side adjacent to the first permanent magnet 5 is the same as the polarity of the magnetic pole of the first permanent magnet 5 at a side facing away from the rotating member 1. Specifically, as shown in FIGS. 1–2, the plurality of pole shoes include a first pole shoe 411 and a second pole shoe 412, and the first pole shoe 411 and the second pole shoe 412 are arranged at intervals in the left-right direction. The third permanent magnet 43 is located between the first pole shoe 411 and the second pole shoe 412, and two ends of the third permanent magnet 43 are respectively attached to the first pole shoe 411 and the second pole shoe 412. The first pole shoe 411 is located between the second permanent magnet 6 and the third permanent magnet 43. A closed magnetic circuit is formed by the third permanent magnet 43, the first pole shoe 411, the second pole shoe 412, and the rotating member 1. Using magnetic energy in the third permanent magnet 43, a non-uniform magnetic field with alternating strength is generated in the gap between the rotating member 1 and the pole teeth, so that the magnetic fluid 42 is adsorbed between the pole teeth and the rotating member 1 to form a sealing ring of the magnetic fluid, thereby blocking the gap between the pole shoe and the shaft to achieve sealing. In addition, the polarity of the magnetic pole at the right side of the third permanent magnet 43 is the same as the polarity of the magnetic pole on an outer ring of the first permanent magnet 5, for example, both are N poles or both are S poles, so that the third permanent magnet 43 and the first permanent magnet 5 simultaneously magnetize the first pole shoe 411 to improve magnetic field strength between the first pole shoe 411 and the rotating member 1.

In some embodiments, the roller device 100 further includes magnetic particles 7. The magnetic particles 7 are filled in at least one of the second gap and the third gap. The lubricating fluid in the bearing 3 is mixable with the magnetic particles 7 to form the magnetic fluid 42 so as to replenish the magnetic fluid 42 to the sealing assembly 4. Specifically, as shown in FIGS. 1–2, the magnetic particles 7 are adsorbed in the second gap and the third gap by the first permanent magnet 5 and the second permanent magnet 6 to achieve magnetic powder sealing. When the rotating member 1 drives the bearing 3 to rotate at a high speed, the lubricating fluid flows out of the bearing 3 into the magnetic particles 7 to mix with the magnetic particles 7. Heat generated by continuous operation of the bearing 3 and friction between the magnetic particles 7 and the first permanent magnet 5, the second permanent magnet 6, and the rotating member 1 provides an environment for preparation of the magnetic fluid 42, so that the magnetic particles 7 react with the lubricating fluid to generate the magnetic fluid 42. Since the first permanent magnet 5, the second permanent magnet 6, and the third permanent magnet 43 all magnetize the first pole shoe 411, magnetic field strength generated by the first pole shoe 411 in the first gap is greater than magnetic field strength generated by the first permanent magnet 5 and the second permanent magnet 6 in the second gap and the third gap. The magnetic fluid 42 prepared from the magnetic particles 7 has fluidity and can flow into the first gap between the first pole shoe 411 and the rotating member 1 under the effect of magnetic field strength, further prolonging the service life of the sealing structure.

In some embodiments, the roller device 100 further includes a magnetic isolation ring 9. The magnetic isolation ring 9 is fitted over the rotating member 1 and located between the bearing 3 and the first permanent magnet 5. An inner circumferential surface of the magnetic isolation ring 9 is spaced apart from the outer circumferential surface of the rotating member 1. Specifically, as shown in FIGS. 1–2, the magnetic isolation ring 9 is made of a non-magnetically conductive material. The magnetic isolation ring 9 is arranged in the mounting seat 2 and fitted over the rotating member 1. The magnetic isolation ring 9 is arranged between the bearing 3 and the first permanent magnet 5, and two ends of the magnetic isolation ring 9 are respectively attached to the bearing 3 and the first permanent magnet 5. The magnetic isolation ring 9 blocks diffusion of a magnetic field generated by the first permanent magnet 5 toward the bearing 3, ensuring that the magnetic field of the first permanent magnet 5 is concentrated on the sealing unit 41 to improve sealing performance.

In some embodiments, the roller device 100 further includes a magnetic conductive ring 8. The magnetic conductive ring 8 is arranged in the mounting seat 2 and fitted over an outer circumferential side of the first permanent magnet 5. One end of the magnetic conductive ring 8 is connected to the sealing unit 41 so that the first permanent magnet 5 magnetizes the sealing assembly 4 via the magnetic conductive ring 8. Specifically, as shown in FIGS. 1–2, the magnetic conductive ring 8 is made of a magnetically conductive material. The magnetic conductive ring 8 is arranged in the mounting seat 2 and fitted over the rotating member 1. The magnetic conductive ring 8 is fitted over outer circumferential sides of the first permanent magnet 5 and the second permanent magnet 6. Left and right ends of the magnetic conductive ring 8 are respectively attached to the first pole shoe 411 and the magnetic isolation ring 9. The magnetic conductive ring 8 concentrates and guides magnetic fields generated by the first permanent magnet 5 and the second permanent magnet 6 to the sealing unit 41, avoiding magnetic field loss, improving magnetic field utilization rate, enabling the sealing unit 41 to obtain a stronger magnetization effect, and thereby enhancing sealing performance.

In some embodiments, the polarity of the magnetic pole of the first permanent magnet 5 at a side facing away from the rotating member 1 is the same as the polarity of the magnetic pole of the second permanent magnet 6 at a side facing away from the rotating member. Specifically, as shown in FIG. 1, the first permanent magnet 5 and the second permanent magnet 6 are both annular and radially magnetized. The polarity of an outer ring of the first permanent magnet 5 is the same as the polarity of an outer ring of the second permanent magnet 6, for example, both are N poles or both are S poles. The outer ring of the first permanent magnet 5 and the outer ring of the second permanent magnet 6 are both attached to an inner ring of the magnetic conductive ring 8, so that the first permanent magnet 5 and the second permanent magnet 6 magnetize the sealing unit 41 via the magnetic conductive ring 8. Since the polarity of the outer ring of the first permanent magnet 5 is the same as the polarity of the outer ring of the second permanent magnet 6, magnetization of the second permanent magnet 6 by the first permanent magnet 5 or magnetization of the first permanent magnet 5 by the second permanent magnet 6 is prevented, ensuring a magnetization effect of the sealing unit 41.

In some embodiments, the sealing unit 41 is provided with a passage (not shown in the figures) penetrating through the sealing unit 41 in the inner-outer direction. One end of the passage communicates with the first gap, and the other end of the passage is configured for introduction of magnetic fluid 42 so that the magnetic fluid 42 flows into the first gap via the passage. Specifically, the first pole shoe 411 or the second pole shoe 412 is provided with a passage penetrating through the first pole shoe 411 or the second pole shoe 412 in an up-down direction. An outlet of the passage is in communication with the first gap, and magnetic fluid 42 can be introduced from an inlet of the passage. By providing a flow path for the magnetic fluid 42, dynamic replenishment and uniform distribution of the magnetic fluid 42 are realized, sealing performance and overall energy efficiency of the device are improved, and the service life of the roller device 100 is prolonged.

In some embodiments, the roller device 100 further includes a blocking member (not shown in the figures). The blocking member is arranged in the passage to block the passage. Specifically, the blocking member may be a rubber blocking cap, which can be inserted into the inlet of the passage to block the passage for normal operation of the roller device 100, or removed to facilitate addition of magnetic fluid 42 to the sealing assembly 4.

In the roller device 100 according to the embodiment of the present disclosure, the sealing assembly 4 is arranged to effectively prevent oil leakage. The design of the first permanent magnet 5 can effectively reduce the velocity difference and contact area between the magnetic fluid 42 and the sealed fluid. A cavity between the second permanent magnet 6 and the pole shoe can form an air layer to prevent direct contact between the magnetic fluid 42 and the sealed fluid. The structure can also self-replenish magnetic fluid. The design of the first permanent magnet 5 and the second permanent magnet 6 can enhance magnetic field strength in the sealing gap. The device solves the problem of lubricating oil leakage existed in conventional roller sealing methods and improves the service life of the roller.

A belt conveyor includes the roller device 100 and a conveyor belt (not shown in the figures).

The roller device 100 is the roller device 100 according to any one of the above embodiments. The conveyor belt is fitted over the roller device 100 so that the roller device 100 drives the conveyor belt to rotate. Thus, the rotating member 1 (such as a rotating shaft and a rotating drum) of the roller device 100 is supported within the mounting seat 2 via the bearing 3. The roller device 100 is installed below or above the conveyor belt to provide stable support for the conveyor belt and materials carried thereby, prevent sagging and deformation of the conveyor belt, and ensure that materials can move smoothly along the conveyor belt.

The belt conveyor according to the embodiment of the present disclosure has advantages such as simple structure and long service life.

In the description of the present disclosure, it should be understood that the orientation or position relationship indicated by the terms "center,", "longitudinal," "transverse," "length," "width," "thickness," "up," "down," "front," "rear," "left," "right," "vertical," "horizontal," "top," "bottom," "inner," "outer," "clockwise," "counterclockwise," "axial," "radial" and "circumferential" and the like, is based on the orientation or position relationship shown in the accompanying drawings, which is only for the convenience of describing the present disclosure and simplifying the description, and does not indicate or imply that the referred device or element must have a specific orientation, and be constructed and operated in a specific orientation, so it cannot be understood as a limitation of the present disclosure.

In addition, the terms "first" and "second" are only used for purpose of description, and cannot be understood as indicating or implying relative importance or implicitly indicating the number of indicated technical features. Therefore, the feature defined as "first" or "second" may explicitly or implicitly include at least one such feature. In the description of the present disclosure, "a plurality of" means at least two, such as two, three, etc., unless otherwise specifically defined.

In the present disclosure, unless otherwise expressly defined, terms such as "install/mount," "interconnect," "connect," "fix" shall be understood broadly, and may be, for example, fixed connections, detachable connections, or integral connections; may also be mechanical or electrical connections or intercommunication; may also be direct connections or indirect connections via intervening media; may also be inner communications or interactions of two elements, unless otherwise specifically defined. For those skilled in the art, the specific meaning of the above terms in the present disclosure may be understood according to the specific situations.

In the present disclosure, unless otherwise expressly defined, the first feature "below," "under," "on bottom of," "above," "on," or "on top of" the second feature may include an embodiment in which the first feature is in direct contact with the second feature, or the first feature is in indirect contact with the second feature through an intermediate media. And, the first feature "above, " "on," or "on top of" the second feature may include an embodiment in which the first feature is right or obliquely "above," "on," or "on top of" the second feature, or just means that the first feature is at a height higher than that of the second feature. The first feature "below," "under," or "on bottom of" the second feature may include an embodiment in which the first feature is right or obliquely "below," "under," or "on bottom of" the second feature, or just means that the first feature is at a height lower than that of the second feature.

In the description of the present disclosure, terms such as "an embodiment," "some embodiments," "an example," "a specific example" or "some examples" means that a particular feature, structure, material, or characteristic described in connection with the embodiment or example is included in at least one embodiment or example of the present disclosure. Thus, the appearances of these terms in various places throughout this specification are not necessarily referring to the same embodiment or example of the present disclosure. Furthermore, the particular features, structures, materials, or characteristics may be combined in one or more embodiments or examples in any suitable manner. In addition, without contradiction, those skilled in the art may combine and unite different embodiments or examples or features of the different embodiments or examples described in this specification.

Although the embodiments of the present disclosure have been shown and described above, it may be understood that the above embodiments are illustrative and shall not be understood as limitation to the present disclosure, and changes, modifications, alternatives and variations may be made in the above embodiments within the scope of the present disclosure by those skilled in the art.

What is claimed is:

1. A roller device for magnetic fluid sealing, comprising:
a rotating member;
a mounting seat and a bearing, wherein the mounting seat has an opening and a mounting cavity in communication with each other, the bearing is configured to contain lubricating fluid and is arranged within the mounting cavity, an end of the rotating member passes through the opening and is fitted within the bearing, and the rotating member is configured to rotate in the mounting seat via the bearing;
a sealing assembly comprising a sealing unit and magnetic fluid, wherein the sealing unit is arranged in the mounting seat and fitted over the rotating member, the sealing unit is located at a side of the bearing adjacent to the opening, an inner circumferential surface of the sealing unit and an outer circumferential surface of the rotating member are spaced apart in an inner-outer direction to form a first gap, and the magnetic fluid fills the first gap to allow the sealing assembly to seal the bearing; and
a first permanent magnet, wherein the first permanent magnet is arranged within the mounting cavity and between the sealing assembly and the bearing, the first permanent magnet is connected to the sealing assembly, the first permanent magnet is configured to magnetize the sealing unit to increase magnetic field strength between the sealing unit and the rotating member, the first permanent magnet is fitted over the rotating member, and an inner circumferential surface of the first permanent magnet is spaced apart from the outer circumferential surface of the rotating member to form a second gap, wherein a spacing of the first gap is equal to a spacing of the second gap, and the first permanent magnet is configured to reduce a velocity difference between the magnetic fluid and the lubricating fluid when the lubricating fluid in the bearing flows into the second gap.

2. The roller device for magnetic fluid sealing according to claim 1, further comprising a second permanent magnet, wherein the second permanent magnet is fitted over the rotating member, an inner circumferential surface of the second permanent magnet is spaced apart from the outer circumferential surface of the rotating member to form a third gap, and the magnetic fluid and the lubricating fluid define an air layer in the third gap; and the second permanent magnet is located between the sealing assembly and the first permanent magnet, two ends of the second permanent magnet are respectively connected to the first permanent magnet and the sealing assembly, and the second permanent magnet magnetizes the sealing unit to increase magnetic field strength between the sealing unit and the rotating member.

3. The roller device for magnetic fluid sealing according to claim 2, wherein the first permanent magnet and the second permanent magnet are integrally formed, a spacing of the third gap is greater than the spacing of the second gap, and a difference between the spacing of the third gap and the spacing of the second gap ranges from 0.01 mm to 1 mm.

4. The roller device for magnetic fluid sealing according to claim 2, wherein a polarity of a magnetic pole at a side of the first permanent magnet facing away from the rotating member is the same as a polarity of a magnetic pole at a side of the second permanent magnet facing away from the rotating member.

5. The roller device for magnetic fluid sealing according to claim 2, wherein the first permanent magnet and the second permanent magnet are integrally formed, a spacing of the third gap is greater than the spacing of the second gap, and a difference between the spacing of the third gap and the spacing of the second gap ranges from 0.01 mm to 1 mm, and
wherein a polarity of a magnetic pole at a side of the first permanent magnet facing away from the rotating member is the same as a polarity of a magnetic pole at a side of the second permanent magnet facing away from the rotating member.

6. The roller device for magnetic fluid sealing according to claim 2, further comprising magnetic particles, wherein the magnetic particles are filled in at least one of the second gap and the third gap, and the lubricating fluid in the bearing is mixable with the magnetic particles to form the magnetic fluid to replenish the magnetic fluid to the sealing assembly.

7. The roller device for magnetic fluid sealing according to claim 1, further comprising a magnetic isolation ring, wherein the magnetic isolation ring is fitted over the rotating member and located between the bearing and the first permanent magnet, and an inner circumferential surface of the magnetic isolation ring is spaced apart from the outer circumferential surface of the rotating member.

8. The roller device for magnetic fluid sealing according to claim 1, wherein the sealing unit comprises:
a plurality of pole shoes, wherein the plurality of pole shoes are arranged within the mounting seat and fitted over the rotating member, a plurality of pole teeth are arranged at intervals on an inner circumferential surface of each pole shoe along a length direction of the rotating member, and the rotating member is spaced apart from the plurality of pole teeth in the inner-outer direction to form the first gap; and
a third permanent magnet, wherein the third permanent magnet is arranged within the mounting seat and fitted over the rotating member, the third permanent magnet is arranged between two adjacent pole shoes, and a polarity of a magnetic pole at a side of the third permanent magnet adjacent to the first permanent magnet is the same as a polarity of a magnetic pole at a side of the first permanent magnet facing away from the rotating member.

9. The roller device for magnetic fluid sealing according to claim 1, further comprising a magnetic conductive ring, wherein the magnetic conductive ring is arranged within the mounting seat and fitted over an outer circumferential side of the first permanent magnet, and an end of the magnetic conductive ring is connected to the sealing unit to allow the first permanent magnet to magnetize the sealing assembly via the magnetic conductive ring.

10. The roller device for magnetic fluid sealing according to claim 1, wherein the sealing unit has a passage penetrating through the sealing unit in the inner-outer direction, an end of the passage is in communication with the first gap, and another end of the passage is configured for introduction of the magnetic fluid, to allow the magnetic fluid to flow into the first gap through the passage.

11. The roller device for magnetic fluid sealing according to claim 10, further comprising a blocking member arranged within the passage to block the passage.

12. A belt conveyor, comprising:
a roller device for magnetic fluid sealing, comprising:
a rotating member;
a mounting seat and a bearing, wherein the mounting seat has an opening and a mounting cavity in communication with each other, the bearing is configured to contain lubricating fluid and is arranged within the mounting cavity, an end of the rotating member passes through the opening and is fitted within the bearing, and the rotating member is configured to rotate in the mounting seat via the bearing;
a sealing assembly comprising a sealing unit and magnetic fluid, wherein the sealing unit is arranged in the mounting seat and fitted over the rotating member, the sealing unit is located at a side of the bearing adjacent to the opening, an inner circumferential surface of the sealing unit and an outer circumferential surface of the rotating member are spaced apart in an inner-outer direction to form a first gap, and the magnetic fluid fills the first gap to allow the sealing assembly to seal the bearing; and
a first permanent magnet, wherein the first permanent magnet is arranged within the mounting cavity and between the sealing assembly and the bearing, the first permanent magnet is connected to the sealing assembly, the first permanent magnet is configured to magnetize the sealing unit to increase magnetic field strength between the sealing unit and the rotating member, the first permanent magnet is fitted over the rotating member, and an inner circumferential surface of the first permanent magnet is spaced apart from the outer circumferential surface of the rotating member to form a second gap, wherein a spacing of the first gap is equal to a spacing of the second gap, and the first permanent magnet is configured to reduce a velocity difference between the magnetic fluid and the lubricating fluid when the lubricating fluid in the bearing flows into the second gap; and
a conveyor belt, wherein the conveyor belt is fitted over the roller device, and the roller device is configured to drive the conveyor belt to rotate.
